(19) United States
(12) Patent Application Publication
(10) Pub. No.: US 2010/0284199 A1
(43) Pub. Date: Nov. 11, 2010

(54) Flashlight holder mountable in a vehicle

(76) Inventor: Jeffrey D. Carnevali, Seattle, WA (US)

Correspondence Address: CHARLES J RUPNICK, PO BOX 46752, SEATTLE, WA, 98146, US

(21) Appl. No.: 12/387,787

(22) Filed: May 7, 2009

(51) Int. Cl. F21V 21/14; B60Q 1/00

(52) U.S. Cl. 362/523; 362/459

(57) ABSTRACT

A flashlight holder formed of a substantially cylindrical lengthwise receptacle having a mouth sized to slidingly receive a flashlight there through, and a stop positioned opposite from the mouth. A clamp mounts the receptacle to a substantially rigid interior surface of a vehicle with the mouth positioned vertically above the stop. The receptacle is a substantially cylindrically tubular receptacle having a substantially constant inside diameter communicating with the mouth. The stop may be formed by a closed end of the receptacle, or a separate end cap affixed to the receptacle.

According to another aspect of the novel flashlight holder, the tubular receptacle is a fishing rod holder mounted as described to the vehicle's interior surface.

### FIELD OF THE INVENTION

The present invention relates to vehicle consoles being mountable within a vehicle driver compartment to support equipment in a location easily accessible to a driver of the vehicle, and in particular to such a vehicle console safe and convenient means for mounting of a standard police-issue flashlight.

### BACKGROUND OF THE INVENTION

Police officers, public safety officers, firefighters, paramedics and the like carry various types of equipment in their vehicles. Several pieces of equipment are often carried in a single vehicle, and the driver often needs to operate the equipment while simultaneously driving the vehicle. Thus, various devices exist to secure multiple pieces of equipment within a vehicle so that they are accessible to the driver and/or other persons in the vehicle driver compartment.

These devices commonly include a hollow rectangular box situated on the floor of the vehicle between the driver seat and front passenger seat, including a horizontal top portion having an upwardly facing opening for receiving pieces of equipment. Police cruisers, for example, are commonly fitted with equipment boxes of this type. The boxes are used to house various types of equipment and controls used by police officers, such as radios, siren controls and light bar controls. Typically, the boxes are sized and positioned so that most of the box extends between the driver seat and the front seat. Only a small portion, if any, of the box will extend forward toward the dashboard beyond the driver seat and front passenger seat. In some police cruisers, the equipment box extends all the way back to the prisoner partition separating the rear seating area from the driver compartment. A laptop computer is often positioned between the box and dashboard, and is secured to the vehicle floor with various types of mounting hardware.

The conventional equipment box configuration described above fails to provide safe and convenient means for mounting of a standard police-issue flashlight.

### SUMMARY OF THE INVENTION

The present invention is a novel flashlight holder for mounting in a vehicle.

According to one aspect of the novel flashlight holder, the flashlight holder is a substantially cylindrical lengthwise receptacle having a mouth sized to slidingly receive a flashlight there through, and a stop positioned opposite from the mouth. A clamp mounts the receptacle to a substantially rigid interior surface of a vehicle with the mouth positioned vertically above the stop. The receptacle is a substantially cylindrically tubular receptacle having a substantially constant inside diameter communicating with the mouth. The stop may be formed by a closed end of the receptacle, or a separate end cap affixed to the receptacle.

According to another aspect of the novel flashlight holder, a vehicle console is provided having a console frame with two opposing side panels and two opposing end panels, and a face plate having portions thereof that are securable with a respective one of the side panels. Here, the interior surface of the vehicle having the receptacle of the novel flashlight holder mounted thereon is selected from the group of interior surfaces consisting of the two side panels of the console frame, the two end panels of the console frame, and the face plate of the console.

According to another aspect of the novel flashlight holder, the interior surface of the vehicle is instead selected from the group of interior surfaces of the vehicle consisting of: a floor surface of the vehicle, and a door surface of the vehicle.

According to another aspect of the novel flashlight holder, the tubular receptacle is a fishing rod holder mounted as described to the vehicle's interior surface.

According to another aspect of the novel flashlight holder, a method is provided of mounting a flashlight holder in a vehicle.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an example of a novel flashlight holder;

FIG. 2 is a perspective bottom view showing mounting of the flashlight holder;

FIG. 3 is a cross-section view showing mounting of the flashlight holder;

FIG. 4 illustrates mounting of the novel flashlight holder on the console; and

FIG. 5 illustrates mounting of the novel flashlight holder on the vehicle floor and door.

### DETAILED DESCRIPTION OF PREFERRED EMBODIMENT

In the Figures, like numerals indicate like elements.

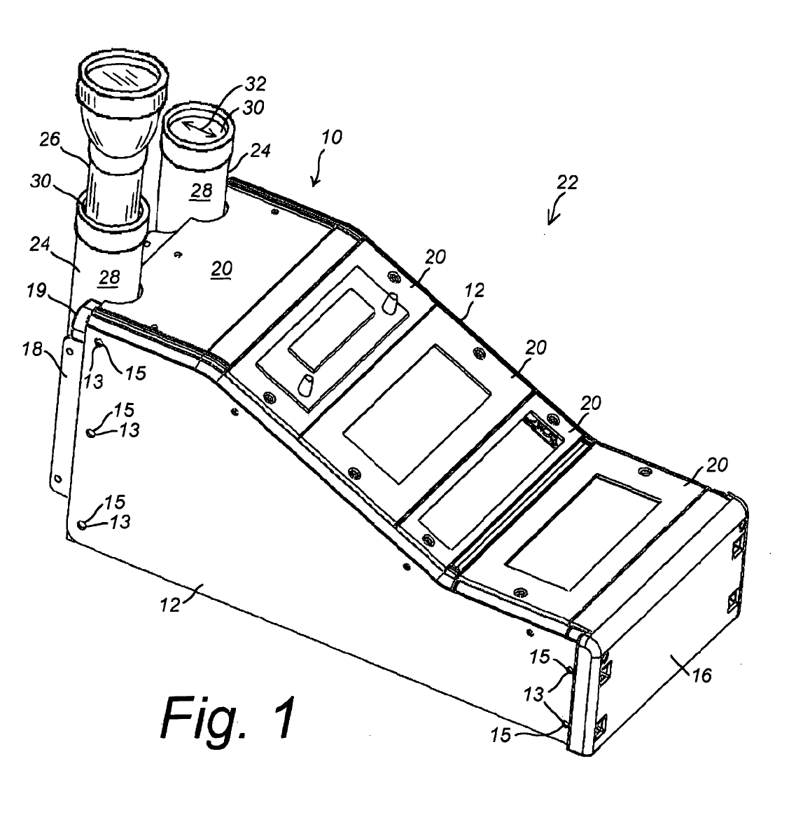

FIG. 1 is a perspective view that illustrates a novel reconfigurable vehicle console 10 having a pair of opposing substantially rigid side panels 12 and opposing substantially rigid end panels 16 and 18. End panels 16, 18 are substantially rigidly interconnected between side panels 12 at one or more cooperating connection points 13 by means of connectors 15. End panels 16, 18 and side panels 12 thereby forming a substantially rectangular support frame 19. A plurality of substantially interchangeable face plates 20 are removably clamped to side panels 12 of the rectangular support frame 19 between the opposing end panels 16, 18 to form a top or upwardly facing surface 22 of console 10.

One or a pair (shown) of flashlight holders 24 are mounted on console 10. For example, flashlight holders 24 are sized to receive a standard police-issue flashlight 26. However, flashlight holders 24 are optionally sized to receive a conventional flashlight, without deviating from the scope and intent of the present invention. As illustrated, according to one embodiment, flashlight holders 24 are optionally provided by a pair of substantially cylindrical tubular fishing rod holders. As further illustrated, flashlight holders 24 are optionally mounted within or as part of face plate 20 of vehicle console 10.

Each flashlight holder 24 is an open tubular receptacle 28 formed of a substantially rigid material with a longitudinal axis and having a mouth opening 30 thereinto. Tubular receptacle 28 is substantially cylindrical with a substantially constant or slightly flared inner diameter 32 sized to slidingly receive flashlight 26. Mouth opening 30 is positioned vertically above tubular receptacle 28, whereby flashlight holder 24 is positioned in a substantially upright orientation.

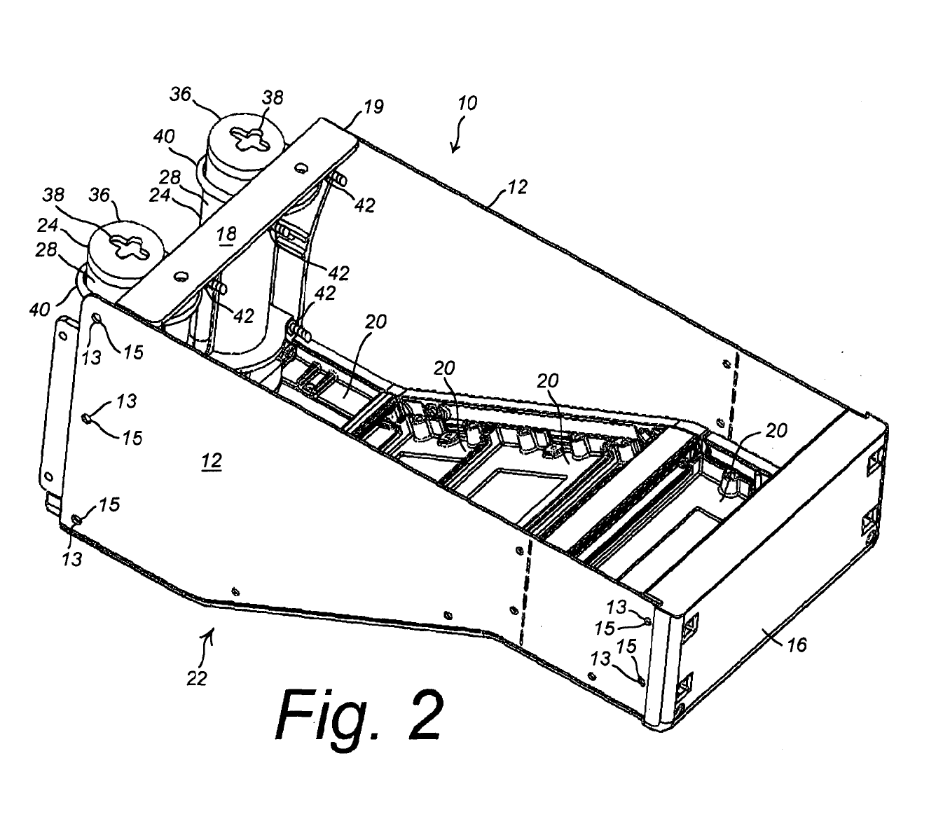

FIG. 2 illustrates receptacle 28 of flashlight holder 24 as being optionally substantially closed by, for example, an end cap 36 opposite from opening 30. End cap 36 is either molded with receptacle 28 or added separately thereto. An optional drain 38 in or near end cap 36 maintains dry conditions within receptacle 28. Each flashlight holder 24 is mounted with opening 30 positioned vertically above end cap 36 which doubles as a stop for flashlight 26. Else, flashlight holder 24 is open at its nether end 34, and opening 30 operates as a collar for supporting the illumination head of flashlight 26. In either open or closed-end configuration, flashlight holder 24 thus operates as a gravity tube for retaining flashlight 26.

Optionally, a clamp 40 secures flashlight holders 24 to vehicle console 10 in their substantially upright orientation with opening 30 positioned vertically above end cap 36. For example, the clamp 40 is one or a pair of threaded fasteners, such as conventional U-bolts (shown), which secure each flashlight holder 24 to mating sockets 42 of vehicle console 10.

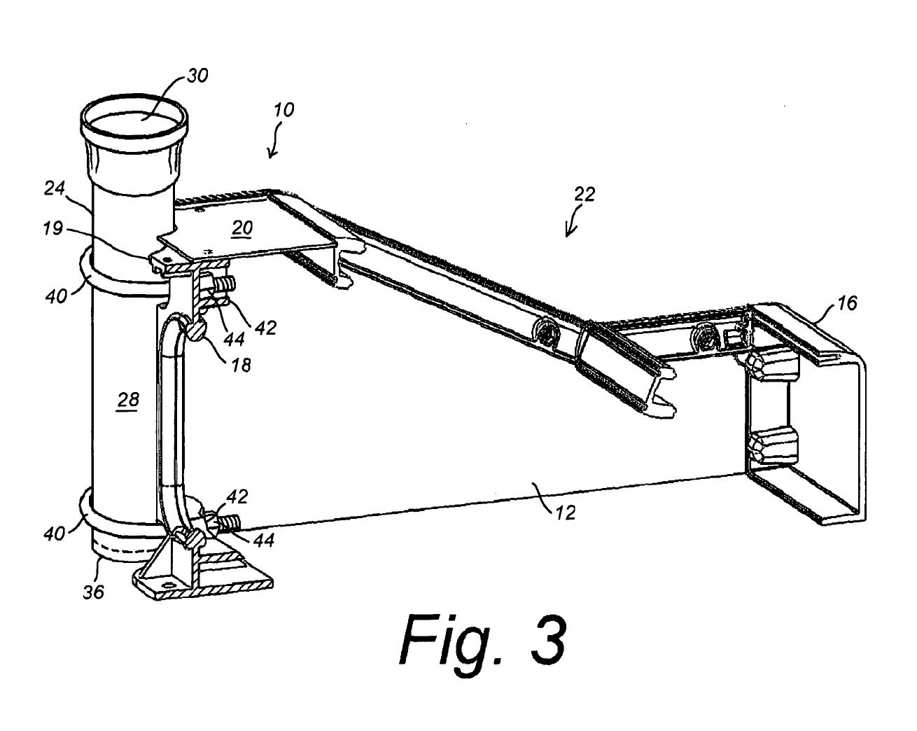

FIG. 3 illustrates clamps 40 securing flashlight holders 24 to vehicle console 10 with mouth opening 30 positioned vertically above receptacle 28. Here, clamps 40 are shown by example and without limitation as conventional threaded U-bolts secured to mating sockets 42 by matching nuts 44. For example, two U-bolt clamps 40 are extended through end panel 18 into mating sockets 42 and secured by nuts 44. Sockets 42 are optionally molded into end panel 18.

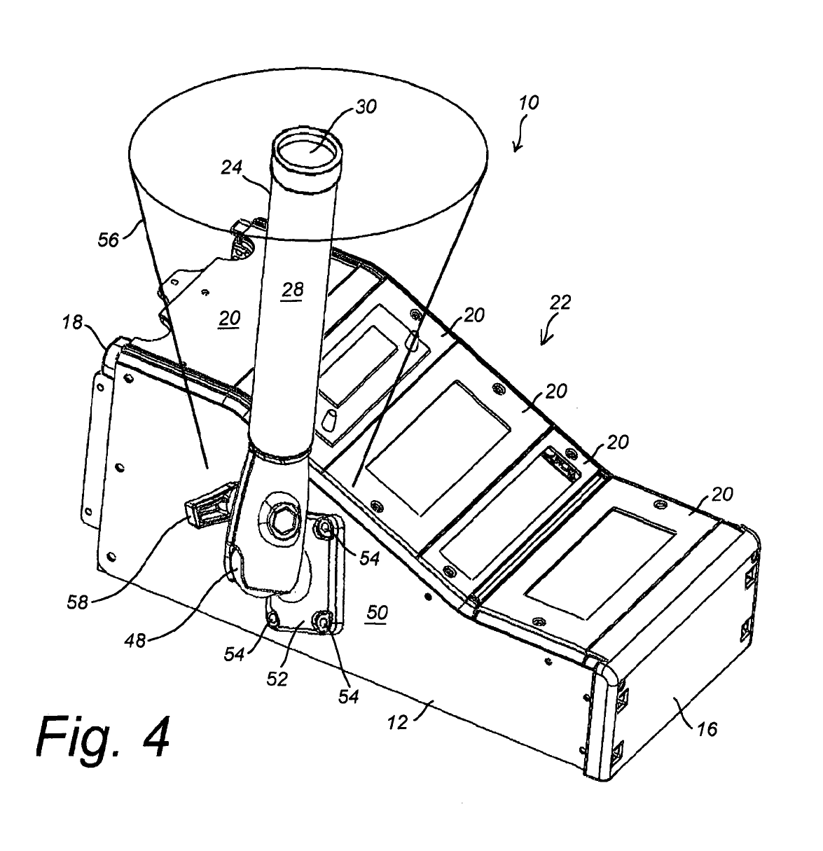

FIG. 4 illustrates flashlight holder 24 secured to vehicle console 10 by an interlockable ball-and-socket clamp 48. By example and without limitation, ball-and-socket clamp 48 secures flashlight holder 24 to an external surface 50 of one substantially rigid side panel 12 or to another external surface of console 10. For example, a base portion 52 of ball-and-socket clamp 48 is secured by any convenient means 54, such as fasteners, to external surface 50 of console 10. Ball-and-socket clamp 48 is a moveable connection which allows the user to manually position flashlight holder 24 from a complete horizontal position throughout an entire conical zone 56 about clamp base 52 merely by loosening a clamping mechanism 58 of ball-and-socket clamp 48. A desired position and orientation is obtained within conical zone 56 by merely grasping and manually positioning flashlight holder 24 while clamping mechanism 58 is loosened. When the desired position and orientation is obtained, clamping mechanism 58 is tightened. Thereafter, the current position and orientation of flashlight holder 24 is maintained until further adjustment by the user is desired, by operating clamping mechanism 58.

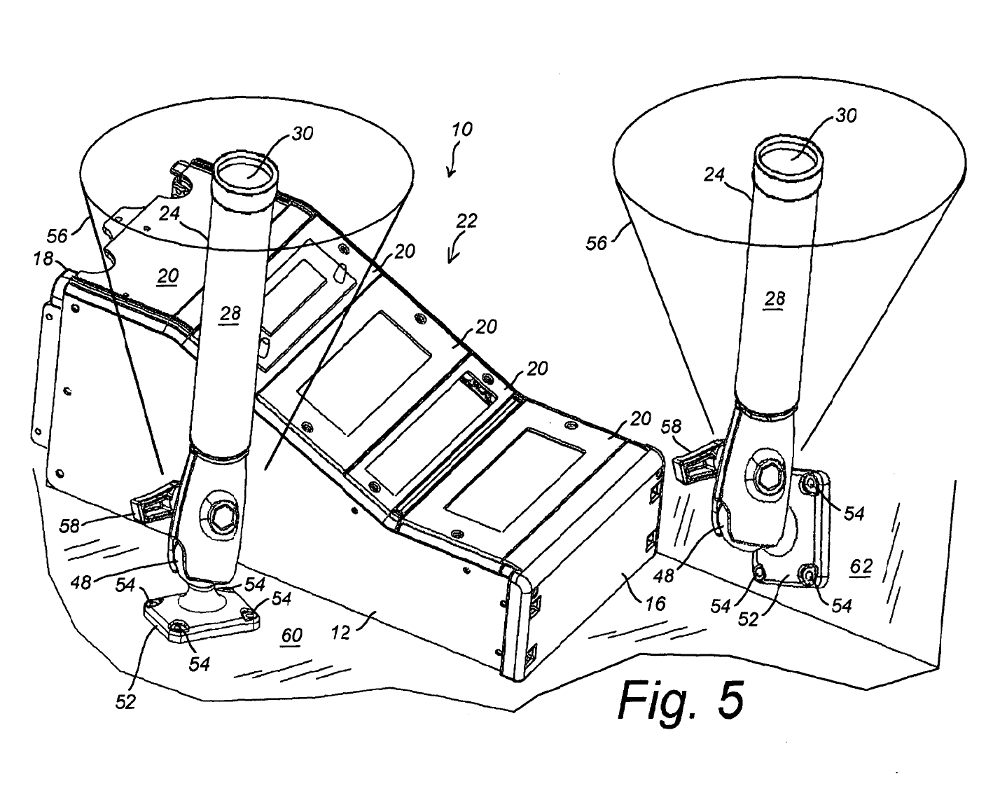

FIG. 5 illustrates flashlight holder 24 secured in an automobile or other vehicle externally vehicle console 10. By example and without limitation, flashlight holder 24 is secured by ball-and-socket clamp 48 directly to a substantially rigid interior vehicle surface, such as the floor surface 60 (shown) or door surface 62 of an automobile or other vehicle. By example and without limitation, ball-and-socket clamp 48 secures flashlight holder 24 to an external vehicle surface 60 adjacent to console 10. For example, base portion 52 of ball-and-socket clamp 48 is secured by any convenient means 54, such as fasteners, to vehicle surface 60 external of console 10. As disclosed herein, moveable connection embodied by ball-and-socket clamp 48 allows the user to manually position flashlight holder 24 from a complete horizontal position throughout the entire conical zone 56 about clamp base 52 merely by loosening a clamping mechanism 58 of ball-and-socket clamp 48. Any desired position and orientation is obtained within conical zone 56 by merely grasping and manually positioning flashlight holder 24 while clamping mechanism 58 is loosened. When the desired position and orientation is obtained, clamping mechanism 58 is tightened. Thereafter, the current position and orientation of flashlight holder 24 is maintained until further adjustment by the user is desired, by operating clamping mechanism 58.

### Method

Vehicle console 10 is mounted in a vehicle by mounting console support frame 19 is mounted in the vehicle with side panels 12 interconnected between opposing end panels 16, 18 by means of connectors 15 at one or more cooperating connection points 13. One or more face plates 20 are mounted in vehicle console 10 by securing portions thereof with at least one of the side panels 12, face plates 20 forming top or upwardly facing surface 22 of console 10.

One or more flashlight holders 24 are provided, for example by conventional tubular fishing rod holders.

According to one embodiment, one or more flashlight holder 24 are mounted in substantially upright orientation in vehicle console 10 by positioning mouth opening 30 vertically above tubular receptacle 28 and securing flashlight holder 24 to vehicle console 10. Flashlight holder 24 is secured in vehicle console 10 by clamping thereto. By example and without limitation, clamping flashlight holder 24 to vehicle console 10 is accomplished by threadedly fastening flashlight holder 24 adjacent to or within one face plate 24. Optionally, threadedly fastening flashlight holder 24 to vehicle console 10 is accomplished by coupling one or a pair of U-bolt clamps 40 into mating sockets 42 of vehicle console 10 and secured with matching nuts 44.

According to another embodiment, flashlight holder 24 is mounted on an external surface of console 10, such as external surface 50 of one side panel 12 or to another external surface. By example and without limitation, ball-and-socket clamp 48 secures flashlight holder 24 to external surface 50 of console 10 by securing base portion 52 of ball-and-socket clamp 48 to external surface 50 by any convenient means 54, such as fasteners (shown). When mounted by a moveable connection such as ball-and-socket clamp 48, flashlight holder 24 is manually positioned throughout entire conical zone 56 about clamp base 52 merely by loosening clamping mechanism 58 of ball-and-socket clamp 48. Flashlight holder 24 is manually positioned while clamping mechanism 58 is loosened. When the desired position and orientation is obtained, clamping mechanism 58 is tightened. Thereafter, the current position and orientation of flashlight holder 24 is maintained until further adjustment by the user is desired, by operating clamping mechanism 58.

Alternatively, flashlight holder 24 is mounted directly on an interior vehicle floor 60 or door 62 external of vehicle console 10. When mounted by a moveable connection such as ball-and-socket clamp 48, flashlight holder 24 is again manually positioned about clamp base 52 throughout the entire conical zone 56.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

1. A flashlight holder for mounting in a vehicle, comprising:
a substantially rigid tubular receptacle comprising a mouth sized to receive a flashlight there through; and
means for mounting the receptacle to an interior surface of a vehicle with the mouth positioned vertically above the tubular receptacle.

2. The flashlight holder of claim 1 wherein the receptacle further comprises a substantially cylindrical elongated tubular receptacle comprising a substantially constant inside diameter.

3. The flashlight holder of claim 2 wherein the tubular receptacle further comprises an end cap positioned opposite from the mouth.

4. The flashlight holder of claim 2 wherein the tubular receptacle further comprises a fishing rod holder.

5. The flashlight holder of claim 2 wherein the means for securing the tubular receptacle further comprises a clamp.

6. The flashlight holder of claim 5 wherein the clamp further comprises an interlockable ball-and-socket clamp.

7. The flashlight holder of claim 6 wherein the ball-and-socket clamp further comprises a base portion and means for securing the base portion to the vehicle surface.

8. The flashlight holder of claim 5, further comprising a vehicle console, comprising:
a console frame comprising two opposing side panels and two opposing end panels; and
a face plate comprising portions thereof securable with a respective one of the side panels; and
wherein the interior surface of the vehicle further comprises one of the console frame and the face plate.

9. The flashlight holder of claim 5 wherein the interior surface of the vehicle further comprises one of a floor surface of the vehicle and a door surface of the vehicle.

10. A flashlight holder for mounting in a vehicle, comprising:
a substantially cylindrical lengthwise receptacle comprising a mouth sized to slidingly receive a flashlight there through, and a stop positioned opposite from the mouth; and
a clamp structured for mounting the receptacle to a substantially rigid interior surface of a vehicle with the mouth positioned vertically above the stop.

10. (canceled)

11. The flashlight holder of claim 21 wherein the stop further comprises a closed end of the receptacle.

12. The flashlight holder of claim 11 wherein the tubular receptacle further comprises a fishing rod holder.

13. The flashlight holder of claim 12, further comprising a vehicle console, comprising:
a console frame comprising two opposing side panels and two opposing end panels; and
a face plate comprising portions thereof securable with a respective one of the side panels; and
wherein the interior surface of the vehicle is further selected from the group of interior surfaces consisting of the two side panels of the console frame, the two end panels of the console frame, and the face plate.

14. The flashlight holder of claim 12 wherein the interior surface of the vehicle is further selected from the group of interior surfaces consisting of: a floor surface of the vehicle, and a door surface of the vehicle.

15. A method of mounting a flashlight holder in a vehicle, comprising:
forming a substantially cylindrical lengthwise receptacle comprising a mouth sized to slidingly receive a flashlight there through, and a stop positioned opposite from the mouth; and
in a vehicle, mounting the receptacle to a substantially rigid interior surface of the vehicle with the mouth positioned vertically above the stop.

16. The method of claim 15 wherein mounting the receptacle further comprises clamping the flashlight holder to the substantially rigid interior surface of the vehicle.

17. The method of claim 16 wherein clamping the flashlight holder further comprises coupling a ball-and-socket clamp between the flashlight holder and the interior surface of the vehicle.

18. The method of claim 17 wherein coupling a ball-and-socket clamp between the flashlight holder and the interior surface of the vehicle further comprises coupling a ball-and-socket clamp between the flashlight holder and one of: a floor surface of the vehicle, and a door surface of the vehicle.

19. The method of claim 16 wherein mounting a flashlight holder in the vehicle console further mounting a fishing rod holder.

20. The method of claim 15, further comprising:
in a vehicle console, mounting a vehicle console comprising opposing side panels interconnected between opposing end panels, and at least one face plate secured to at least one of the side panels;
mounting a flashlight holder to the vehicle console, wherein mounting the flashlight holder further comprises securing the flashlight holder to an external surface of the vehicle console; and
positioning a flashlight receiving mouth of the flashlight holder vertically above a tubular receptacle thereof.

21. The flashlight holder of claim 10 wherein the receptacle further comprises a substantially cylindrically tubular receptacle comprising a substantially constant inside diameter communicating with the mouth.
